(19) United States
(12) Patent Application Publication
(10) Pub. No.: US 2006/0170708 A1
(43) Pub. Date: Aug. 3, 2006

(54) Circuits for processing encoded image data using reduced external memory access and methods of operating the same

(75) Inventor: Seung-June Kyoung, Gyeonggi-do (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 11/340,356

(22) Filed: Jan. 26, 2006

(30) Foreign Application Priority Data
Feb. 2, 2005 (KR) 10-2005-0009678

(51) Int. Cl. G09G 5/02

(52) U.S. Cl. 345/648; 345/603

(57) ABSTRACT

A circuit for providing image data for display can include a signal conversion unit configured to receive JPEG decompressed image data organized as horizontal block lines of an image directly from a JPEG compliant decoding unit.

### CROSS-REFERENCE TO RELATED PATENT APPLICATIONS

This application claims the benefit of Korean Patent Application No. 10-2005-0009678, filed on Feb. 2, 2005, in the Korean Intellectual Property Office, the disclosure of which is incorporated herein in its entirety by reference.

### FIELD OF THE INVENTION

The present invention relates to an apparatus for and method of displaying encoded image data, and more particularly, to an apparatus for and method of displaying joint photographic experts group (JPEG) image data under a mobile multimedia environment.

### BACKGROUND

FIG. 1 is a block diagram of an apparatus for displaying JPEG image data in a mobile multimedia environment. Referring to FIG. 1, the display apparatus includes a camera interface unit 180.

An operation displaying camera image data received from the outside will now be explained. First, the camera interface unit 180 receives (uncoded) camera image data. The camera interface unit 180 post-processes the camera image data. For example, the camera interface unit 180 scales the size of the camera image data to be displayed on the screen. Then, the camera interface unit 180 rotates the location of the camera image data to be displayed on the screen.

The camera image data post-processed by the camera interface unit 180 is recorded in a frame buffer 160 through a preview port 185. A display control unit 170 reads the image data stored in the frame buffer 160. According to the read image data, the display control unit 170 outputs an RGB signal. The RGB signal is displayed on an external screen.

Meanwhile, if the shutter of the camera is pressed, the camera interface unit 180 records an image signal in an external memory. At this time, the camera image signal is transmitted through a codec port 187 and recorded through a memory control unit 120.

An operation for displaying JPEG image data will now be explained. A CPU interface unit 110 receives JPEG image data from an external CPU. The received JPEG image data is recorded in an external memory through the memory control unit 120 (arrow 1). A JPEG decoding unit 130 reads the JPEG image data through the memory control unit 120 (arrow 2). The JPEG decoding unit 130 decodes the read JPEG image data. The decoded image data (raw data) is recorded in an external memory again through the memory control unit (arrow 3).

A rotator 140 reads the decoded image data through the memory control unit 120 (arrow 4). The rotator 140 rotates the location of the read image data to be displayed on the screen. The rotated image data is recorded again in the memory through the memory control unit 120 (arrow 5).

A post processor 150 reads the rotated image data through the memory control unit 120 (arrow 6). The post processor 150 post-processes the read image data. For example, the post processor 150 scales the size of the read image data to be displayed on the screen. The post-processed image data is recorded in the frame buffer 160 again through the memory control unit 120 (arrow 7).

The display control unit 170 outputs an RGB signal according to the read image data. The RGB signal is displayed on an external screen (arrow 8). As shown, the display apparatus described above and shown in FIG. 1 uses a separate hardware block, such as the rotator 140 or the post processor 150, in order to display JPEG image data. Power consumption may also be high and a bottleneck in memory access may occurs dues to the number of hardware blocks writing/reading data to/from the external memory. Accordingly, the display apparatus generally uses a higher system clock speed, which may be difficult to implement in a chip.

### SUMMARY

Embodiments according to the invention can provide circuits for processing encoded image data using reduced external memory access and methods of operating the same. Pursuant to these embodiments, a circuit for providing image data for display can include a signal conversion unit configured to receive JPEG decompressed image data organized as horizontal block lines of an image directly from a JPEG compliant decoding unit. In some embodiments according to the invention, the JPEG compliant decoding unit is configured to decode encoded image data to provide the JPEG decompressed image data under control of the signal conversion unit.

In some embodiments according to the invention, the signal conversion unit further includes a data buffer having a capacity to store a single horizontal block line of JPEG decompressed image data. In some embodiments according to the invention, the signal conversion unit provides a stop signal to the JPEG compliant decoding-unit when the data buffer is full. In some embodiments according to the invention, the signal conversion unit provides a start signal to the JPEG compliant decoding unit when the data buffer is empty.

In some embodiments according to the invention, the signal conversion unit is further configured to operate on the JPEG decompressed image data in the data buffer when the data buffer is not empty. In some embodiments according to the invention, the signal conversion unit is further configured to stop a pixel clock signal to a camera interface circuit when the data buffer is empty.

In some embodiments according to the invention, the data buffer is a first data buffer, and the signal conversion unit further includes a second data buffer configured to store JPEG decompressed image data when the first data buffer is full. In some embodiments according to the invention, the signal conversion unit is further configured to operate on the JPEG decompressed image data without reading the JPEG decompressed image data from an external memory outside the signal conversion unit and outside the JPEG compliant decoding unit.

In some embodiments according to the invention, a circuit further includes a camera interface unit configured to receive the camera image data from the signal conversion unit, wherein the camera interface unit provides prost processing of the camera image data including rotation of the camera image data and/or scaling of the camera image data.

### BRIEF DESCRIPTION OF THE DRAWINGS

FIG. 1 is a block diagram of an apparatus for displaying JPEG image data generally under a mobile multimedia environment;

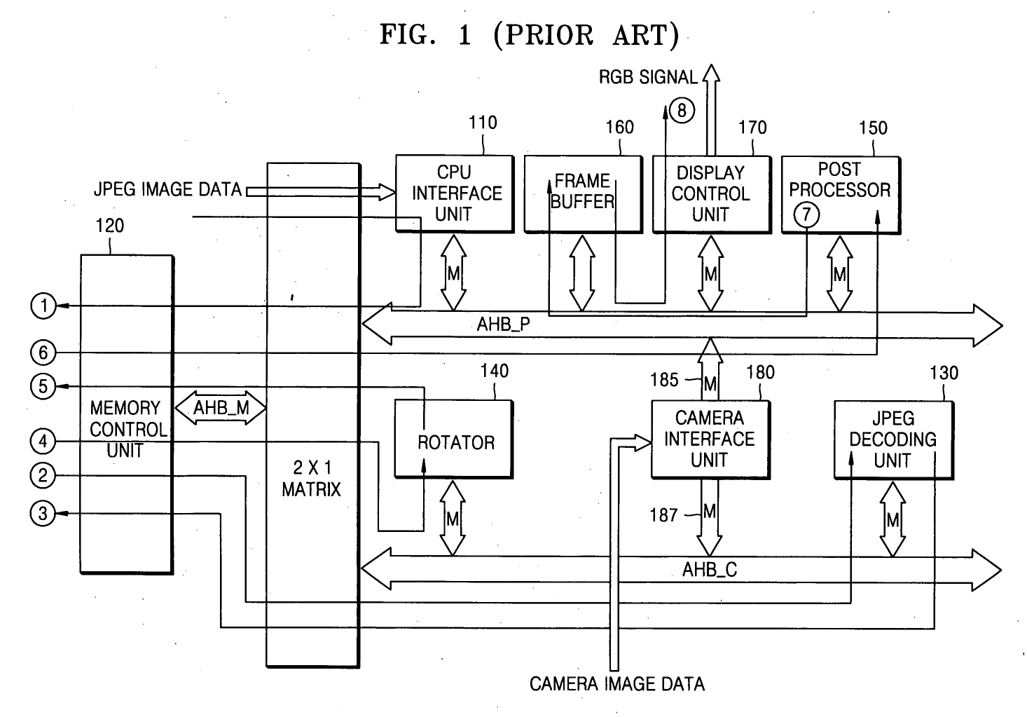

FIG. 2 is a block diagram of a display apparatus according to some embodiments of the present invention;

FIG. 3 illustrates JPEG image data in the display apparatus of FIG. 2;

FIG. 4 is a flowchart of the operations performed by a display method according to some embodiments of the present invention;

FIG. 5 is a first flowchart of the data conversion operation of the display method of FIG. 4; and

FIGS. 6A and 6B are a second flowchart of the data conversion operation of the display method of FIG. 4.

### DESCRIPTION OF EMBODIMENTS ACCORDING TO THE INVENTION

The present invention now will be described more fully hereinafter with reference to the accompanying figures, in which embodiments of the invention are shown. This invention may, however, be embodied in many alternate forms and should not be construed as limited to the embodiments set forth herein. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein the term “and/or” includes any and all combinations of one or more of the associated listed items.

It will be understood that, when an element is referred to as being “coupled” to another element, it can be directly coupled to the other element or intervening elements may be present. In contrast, when an element is referred to as being “directly coupled” to another element, there are no intervening elements present.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense expressly so defined herein.

The present invention is described below with reference to diagrams (such as block diagrams, schematic diagrams, and flowcharts) and/or operational illustrations of methods, modems, systems and computer program products according to some embodiments of the invention. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

The present invention may be embodied in hardware and/or in software (including firmware, resident software, micro-code, etc.) including a combination of both. For example, JPEG decoding units according to some embodiments of the invention may be implemented as a processor circuit that operates according to software executed by the JPEG decoding unit. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM).

Computer program code or “code” for carrying out operations according to the present invention may be written in an object oriented programming language such as JAVA®, Smalltalk or C++, JavaScript, Visual Basic, TSQL, Perl, or in various other programming languages. Software embodiments of the present invention do not depend on implementation with a particular programming language. Portions of the code may execute entirely on one or more systems utilized by an intermediary server.

The computer program code may be provided to a processor of a general purpose computer, special purpose computer, or other programmable data processing apparatus as instructions to produce a machine, such that the instructions, which execute via the processor of the computer or other programmable data processing apparatus, create means for implementing the functions specified in the block and/or flowchart block or blocks.

The computer code may be stored in a computer-readable memory that can direct a computer or other programmable data processing apparatus to function in a particular manner, such that the instructions stored in the computer-readable memory produce an article of manufacture including instruction means which implement the function specified in the block diagrams and/or flowchart block or blocks.

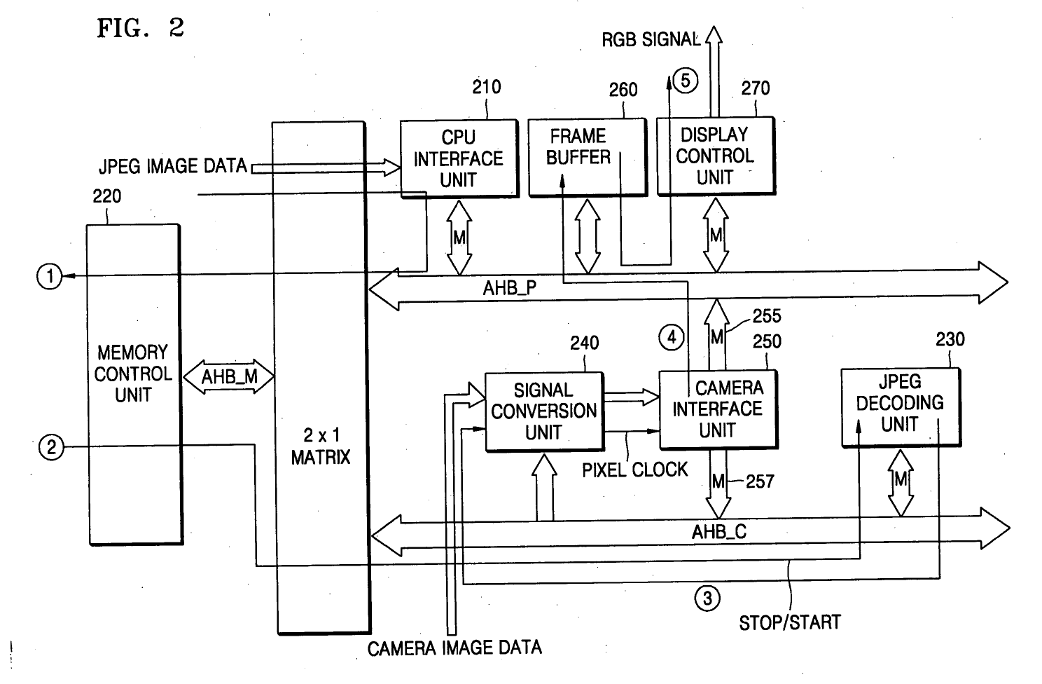

Referring to FIG. 2 showing a display apparatus according to an embodiment of the present invention, as buses for transmitting data, an AHB_M bus, an AHB_P bus and an AHB_C bus are used.

The AHB bus is a bus transmitting a signal between hardware blocks inside a chip. The AHB is a standardized specification (SPEC) of those buses. M, P, and C are subscripts distinguishing respective buses. A 2×1 matrix switches the AHB_M bus between the AHB_P bus and the AHB_C bus. M inside an arrow mark between each bus and a hardware block indicates that the corresponding hardware block operates as a master. An arrow with a single arrowhead indicates that the corresponding hardware block executes a write operation as a master. An arrow with double arrowheads indicates that the corresponding hardware block executes a write operation and a read operation as a master.

A CPU interface unit 210 transmits data received from an external CPU, to a corresponding hardware block. The CPU interface unit 210 receives JPEG image data from the CPU. The received JPEG image data is recorded in an external memory through a memory control unit 220 (arrow 1).

Generally, the Joint Photographic Experts Group (JPEG) developed what is commonly referred to as the “JPEG standard” or simply “JPEG.” As used herein, JPEG refers to an international compression standard for continuous tone (i.e., grayscale and color) images. The JPEG compression format is “lossy” compression, in that some image data may be deleted to increase compression ratios. JPEG files can be compressed by variable amounts ranging relatively little compression resulting in essentially “lossless” compression to relatively high compression resulting in lossy compression.

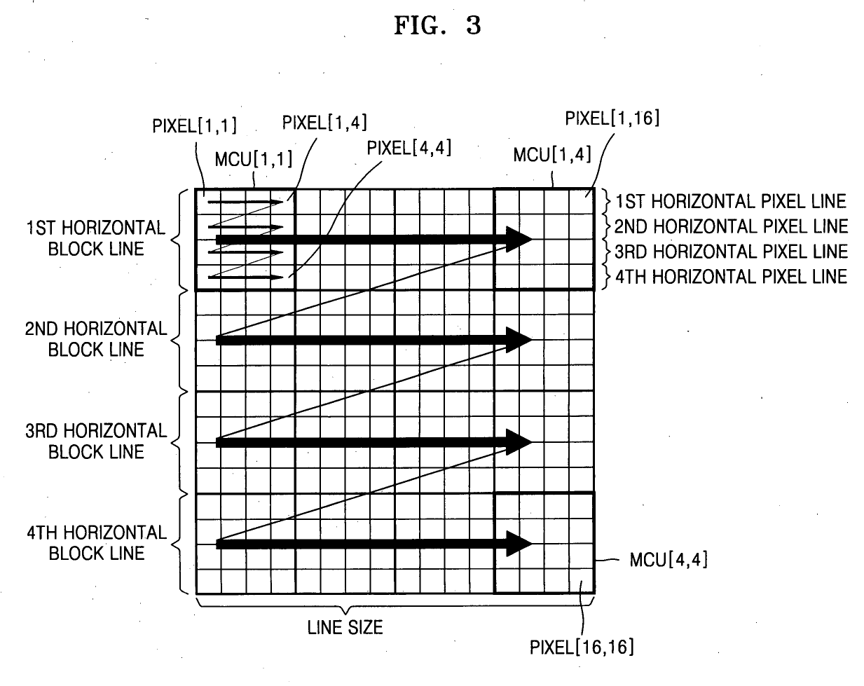

FIG. 3 illustrates JPEG image data in the display apparatus of FIG. 2. Referring to FIG. 3, an image is divided into square pixel blocks. A pixel block is formed with a plurality of pixels. The pixel block is also referred to as a minimum coded unit (MCU). The size of the MCU in FIG. 3 is 4×4. In FIG. 3, the MCU is formed with 16 pixels.

In the JPEG, an image is encoded in order of horizontal block line as indicated by thick arrows.

That is, a first horizontal block line (MCUs [1,1] through [1,4]) is first encoded. Then, a second horizontal block line (MCUs [2,1] through [2,4]), a third horizontal block line (MCUs [3,1] through [3,4]), and a fourth horizontal block line (NCUs [4,1] through [4,4]), are encoded in order.

Accordingly, the image is encoded in order of MCU [1,1]−>MCU [1,2]−>MCU [1,3]−>MCU [1,4]−>MCU [2,1]−> . . . MCU [2,4]−>MCU [3,1]−> . . . MCU [3,4]−>MCU [4,1]−> . . . MCU [4,4].

In each MCU, encoding is performed in order of horizontal pixel line as indicated by thin arrows of FIG. 3.

For example, inside the MCU [1,1], a first horizontal pixel line (pixels [1,1] through [1,4]) is first encoded. Then, a second horizontal pixel line (pixels [2,1] through [2,4]), a third horizontal pixel line (pixels [3,1] through [3,4]), and a fourth horizontal pixel line (pixels [4,1] through [4,4]), are encoded in order.

Accordingly, the MCU [1,1] is encoded in order of pixel [1,1]−>pixel [1,2]−>pixel [1,3]−>pixel [1,4]−>pixel [2,1]−> . . . pixel [2,4]−>pixel [3,1]−> . . . pixel [3,4]−>pixel [4,1]−> . . . pixel [4,4].

Referring again to FIG. 2, the memory control unit 220 controls recoding data in an external memory. Also, the memory control unit 220 controls reading data recorded in the external memory.

The JPEG decoding unit 230 reads JPEG image data recorded in the external memory (arrow 2). The order of decoding the JPEG image data is the same as the order of encoding the image data into the JPEG image data.

Referring to FIG. 3, the JPEG decoding unit 230 decodes the JPEG image data in order of horizontal block line as indicated by thick arrows.

Accordingly, the JPEG decoding unit 230 decodes the data in order of MCU [1,1]−>MCU [1,2]−>MCU [1,3]−>MCU [1,4]−>MCU [2,1]−> . . . MCU [2,4]−>MCU [3,1]−> . . . MCU [3,4]−>MCU [4,1]−> . . . MCU [4,4].

The JPEG decoding unit 230 decodes each MCU in order of horizontal pixel line as indicated by thin arrows of FIG. 3.

For example, the JPEG decoding unit 230 decodes the MCU [1,1] in order of pixel [1,1]−>pixel [1,2]−>pixel [1,3]−>pixel [1,4]−>pixel [2,1]−> . . . pixel [2,4]−>pixel [3,1]−> . . . pixel [3,4]−>pixel [4,1]−> . . . pixel [4,4].

Referring again to FIG. 2, the JPEG decoding unit 230 transmits the decoded image data (i.e., decompressed or raw data) to the signal conversion unit 240 in an on-the-fly method (arrow 3). The on-the-fly method is a method by which data is directly processed without passing through an external memory. In some embodiments according to the invention, the decoded image data (raw data) is transmitted directly from the JPEG decoding unit 230 to the signal conversion unit without reading the JPEG decompressed image data from an external memory. It will be understood that in some embodiments according to the invention, the external memory does not include buffers and other storage circuits included in the signal conversion unit and the JPEG compliant decoding unit.

The JPEG decoding unit 230 transmits the decoded image data as if the data is to be recorded in the external memory. But, the JPEG decoding unit 230 sets the destination address to the address of the signal conversion unit 240, not to an address of the memory control unit 220.

If a part of the JPEG image data corresponding to a horizontal block line is decoded, the signal conversion unit 240 converts the decoded image data into camera image data. The camera image data is image data in which pixels forming an image are arranged in order of horizontal pixel line.

That is, in FIG. 3, the camera image data is the image data in which pixels are arranged in order of the first horizontal pixel line (pixels [1,1] through [1,4]), the second horizontal pixel line (pixels [2,1] through [2,4]), the third horizontal pixel line (pixels [3,1] through [3,4]), and the fourth horizontal pixel line (pixels [4,1] through [4,4]).

The signal conversion unit 240 stores the image data decoded in the JPEG decoding unit 230 in a buffer. The signal conversion unit 240 may have one buffer or two buffers.

Each buffer has a size enough to store the decoded image data of at least one horizontal block line. For example, in FIG. 3, each buffer has a size enough to store the decoded image of at least 4 MCUs.

The camera image data is in order of horizontal pixel line. Accordingly, even though the decoded image data of the MCU [1,1] is stored in the buffer, the signal conversion unit 240 does not begin conversion.

The signal conversion unit 240 waits until the decoded image data of the horizontal block line (MCUs [1,1] through [1,4]) is stored in the buffer. Only after the decoded image data of the horizontal block line is stored in the buffer, the conversion unit 240 begins conversion of the data in order horizontal pixel line.

The signal conversion unit 240 transmits the converted image data to the camera interface unit 250.

A case where the signal conversion unit 240 has one buffer will now be explained.

If the decoded image data of a horizontal block line is stored in the buffer, the signal conversion unit 240 transmits a stop signal to the JPEG decoding unit 230. That is, the signal conversion unit 240 stops the decoding operation of the JPEG decoding unit 230.

This is to prevent the image data stored in the buffer from being changed by storing the decoding image data of another horizontal block line, before all the image data is converted and transmitted to the camera interface unit 250.

If the signal conversion unit 240 converts all the image data stored in the buffer and transmits to the camera interface unit 250, the signal conversion unit 240 clears the stop signal. That is, the signal conversion unit 240 restarts the decoding operation of the JPEG decoding unit 230.

While the decoded image data is filled in the buffer again, the signal conversion unit 240 holds the pixel clock of the camera interface unit 250 at 0. This pixel clock is used for the camera interface unit 250 to receive the converted image data from the signal conversion unit 240.

If the decoded image data of the next horizontal block line is stored in the buffer, the signal conversion unit 240 again stops the decoding operation of the JPEG decoding unit 230. Then, according to the enabled pixel clock, the signal conversion unit 240 receives the image data converted in the signal conversion unit 240.

So far, the case where the signal conversion unit 240 has one buffer is described above, and a case where the signal conversion unit 240 has two buffers will now be explained.

If the decoding unit 230 decodes the first horizontal block line, the signal conversion unit 240 stores the decoded image data of the first horizontal block line in a first buffer.

However, if the decoding unit 230 completes decoding of the first horizontal block line and then decodes a second horizontal block line, the signal conversion unit 240 stores the decoded image data of the second horizontal block line in a second buffer.

If the decoding unit 230 completes decoding of the second horizontal block line and then decodes a third horizontal block line, the signal conversion unit 240 stores the decoding image data of the third horizontal block line again in the first buffer.

That is, the signal conversion unit 240 stores the decoded image data in the two buffers alternately according to the change of the horizontal block line being decoded by the decoding unit 230.

While storing the decoded image data of one buffer, the signal conversion unit 240 can convert the image data of the other buffer. Accordingly, the decoding unit 230 can continuously decode the JPEG image data without stopping. As a result, the time taken to decode the entire JPEG image data is reduced.

The speed at which the signal conversion unit 240 converts the decoded image data is equal to or higher than the speed at which the decoding unit 230 decodes encoded image data. That is, the speed of conversion of the decoded image data is equal to or higher than the speed of storing the decoded image data in the buffer. Accordingly, an overflow does not occur.

If the image data stored in the first buffer is all converted and transmitted to the camera interface unit 250 before the decoded image data of the horizontal block line is all stored in the second buffer, the signal conversion unit 240 stops the pixel clock of the camera interface unit 250. By doing so, the buffer under-run problem can be prevented.

So far, the case where the signal conversion unit 240 has two buffers is described.

The signal conversion unit 240 can directly receive camera image data from the outside.

The camera interface unit 250 receives camera image data from the signal conversion unit 240 according to the pixel clock. The camera interface unit 250 post-processes the camera image data.

For example, the camera interface unit 250 scales the size of the camera image data to be displayed on the screen. Then, the camera interface unit 250 rotates the location of the camera image data to be displayed on the screen.

The camera interface unit 250 records the camera image data in the frame buffer 260 through a preview port 255 (arrow 4).

Meanwhile, if a camera shutter is pressed, the camera interface unit 250 records a camera image signal in an external memory. At this time, the camera image signal is transmitted through a CODEC port 257 and recorded through the memory control unit 220.

The display control unit 270 reads the camera image recorded in the frame buffer 260. The display control unit 270 outputs an RGB signal according to the read image data. The RGB signal is displayed on the external screen (arrow 5).

The size and location of the displayed image can be adjusted as desired by using the rotation function and scaling function of the camera interface unit 250.

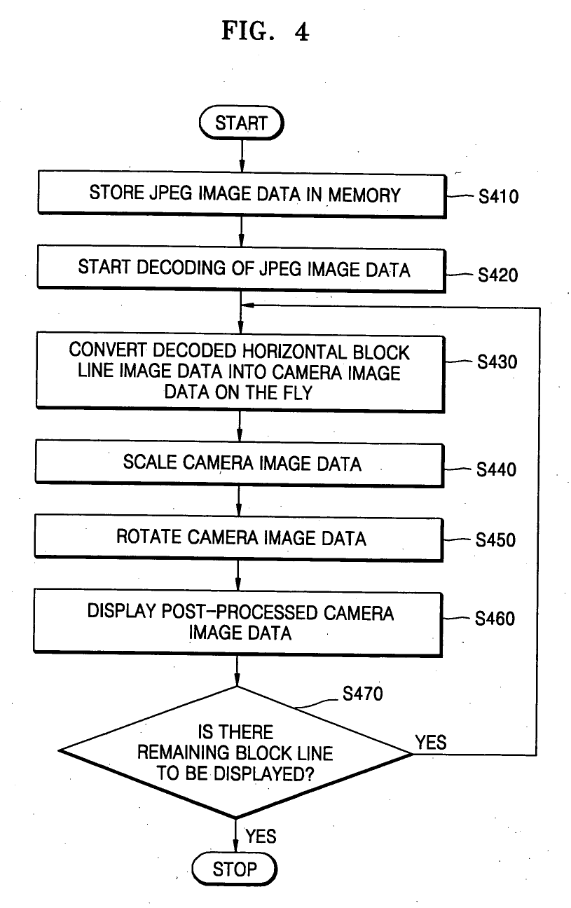

FIG. 4 is a flowchart of the operations performed by a display method according to some embodiments of the present invention. Referring to FIG. 4, JPEG image data to be decoded is stored in a memory in operation S410. A JPEG decoding unit begins decoding of the JPEG image data stored in the memory in operation S420.

If the JPEG decoding unit decodes a part corresponding to a horizontal block line, of the encoded image data, the signal conversion unit 240 converts the decoded image data of the horizontal block line into camera image data in operation S430. The data conversion is performed in the on-the-fly method.

That is, the camera interface unit 250 scales the size of the converted camera image data to be displayed on the screen in operation S440. Then, the camera interface unit 250 rotates the location of the converted camera image data to be displayed on the screen in operation S450.

The display control unit 270 controls the post-processed camera image data such that the horizontal block line is displayed in operation S460.

If still there is a remaining horizontal block line to be displayed in operation S470, the operations S430 through S460 are performed repeatedly so that the entire image is displayed.

A user can adjust as desired the size and location of the horizontal pixel block line displayed by using the rotation function and scaling function of the camera interface unit 250.

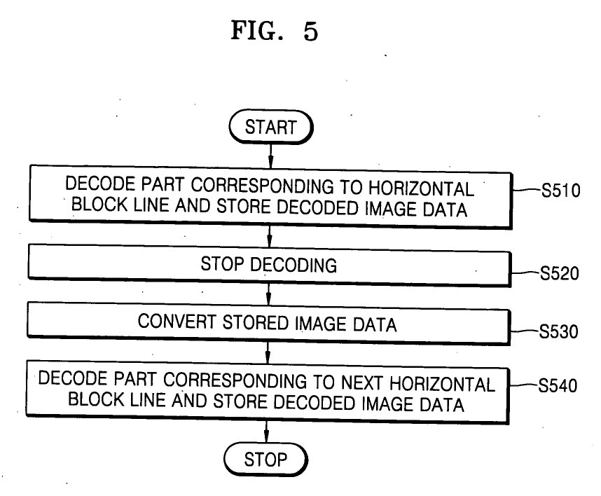

FIG. 5 is a first flowchart of the data conversion operation S430 of the display method of FIG. 4. Referring to FIG. 5, the JPEG decoding unit 230 decodes a part corresponding to a horizontal block line, of the encoded image data in operation S510. The signal conversion unit 240 stores the decoded image data of the horizontal block line in a buffer in operation S510.

If all the decoded image data of the horizontal block line is stored, the signal conversion unit 240 stops the decoding operation of the JPEG decoding unit 230 in operation S520.

Then, the signal conversion unit 240 converts the image data stored in the buffer into camera image data in operation S530. The signal conversion unit 240 transmits the converted camera image data to the camera interface unit 250.

If all the image data stored in the buffer is transmitted, the signal conversion unit 240 restarts the decoding operation of the decoding unit 230. Accordingly, the JPEG decoding unit 230 restarts decoding of a part corresponding to a next horizontal block line in operation S540. Then, the signal conversion unit 240 stores the decoded image data in the buffer in operation S540.

The above operations S520 through S540 are repeatedly performed for other horizontal block lines such that the entire image is displayed.

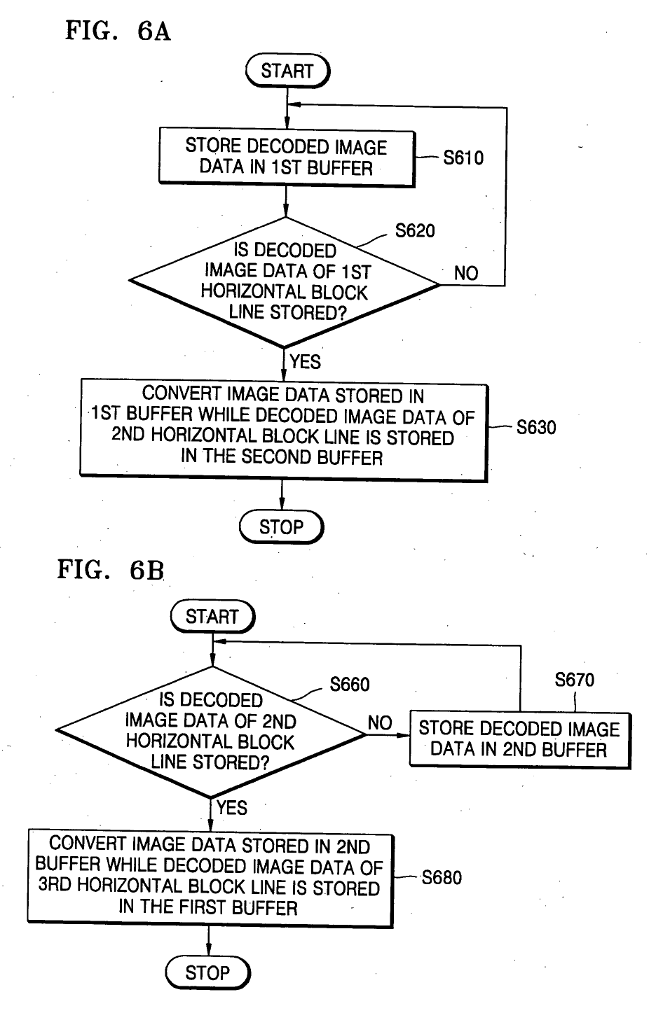

FIGS. 6A and 6B are a second flowchart of the data conversion operation S430 of the display method of FIG. 4. Referring to FIG. 6A, the signal conversion unit 240 stores the decoded image data in the first buffer in operation S610.

If the decoded image data of the first horizontal block line is stored in the first buffer in operation S620, the signal conversion unit 240 stores the decoded image data of the second horizontal block line in the second buffer in operation S630.

While the image data is stored in the second buffer, the signal conversion unit 240 converts the image data stored in the first buffer into camera image data in operation S630. At this time, the speed at which the image data is converted is equal to or higher than the speed at which the image data is stored. That is, the speed of converting the decoded image data is equal to or higher than the speed of decoding the JPEG image data.

Referring to FIG. 6B, if all the image data stored in the first buffer is converted but the decoding image data of the second horizontal block line is not stored in the second buffer in operation S660, the signal conversion unit 240 continuously stores the decoded image data in the second buffer in operation S670.

If the decoded image data of the second horizontal block line is stored in the second buffer in operation S660, the signal conversion unit 240 stores the decoded image data of the third horizontal block line in the first buffer in operation S680.

While the image data is stored in the first buffer, the signal conversion unit 240 converts the image data stored in the second buffer into camera image data in operation S680.

According to the present invention as described above, a separate rotator and post processor may not be required in order to decompress/display JPEG image data. Also, bandwidth requirements to an external memory and power may be reduced. Furthermore, according to the present invention, the size of a chip may be reduced and the clock speed of an entire system may be reduced such that implementation of a chip can be easily performed.

While the present invention has been particularly shown and described with reference to exemplary embodiments thereof, it will be understood by those of ordinary skill in the art that various changes in form and details may be made therein without departing from the spirit and scope of the present invention as defined by the following claims. The embodiments should be considered in descriptive sense only and not for purposes of limitation. Therefore, the scope of the invention is defined not by the detailed description of the invention but by the appended claims, and all differences within the scope will be construed as being included in the present invention.

What is claimed:

1. A display apparatus for displaying encoded image data which is obtained by encoding an image divided into pixel blocks, in order of horizontal block line, and by encoding the data in each pixel block in order of horizontal pixel line, the apparatus comprising:
a decoding unit configured to decode the encoded image data;
a conversion unit, coupled to the decoding unit, configured so that if the decoding unit decodes a part corresponding to a horizontal block line, of the encoded image data, converting the decoded image data into image data arranged in order of horizontal pixel line; and
an interface unit, coupled to the conversion unit, configure to scale the size of the converted image data to be displayed on the screen.

2. The apparatus of claim 1, wherein the conversion unit stores the decoded image data in a storage unit, and if the decoded image data of a horizontal block line is stored in the storage unit, stops the decoding operation of the decoding unit and converts the stored image data, and if the conversion is completed, restarts the decoding operation of the decoding unit.

3. The apparatus of claim 1, wherein the conversion unit stores the decoded image data in two storage units alternately according to the change of a horizontal block line decoded by the decoding unit, and concurrently performs converting the stored image data and storing the decoded image data.

4. The apparatus of claim 1, wherein the converting speed of the decoded image data is equal to or higher than the decoding speed of the encoded image.

5. The apparatus of claim 1, wherein the interface unit rotates the location of the converted image data to be displayed on the screen.

6. A display method for displaying encoded image data which is obtained by encoding an image divided into pixel blocks, in order of horizontal block line, and by encoding the data in each pixel block in order of horizontal pixel line, the apparatus comprising:
decoding a part corresponding to a first horizontal block line, of the encoded image data;
converting the decoded image data into image data arranged in order of horizontal pixel line; and
scaling the size of the converted image data to be displayed on the screen.

7. The method of claim 6, wherein the converting of the decoded image data further comprises:
if the converting is completed, decoding a part corresponding to a second horizontal block line, of the encoded image data.

8. The method of claim 6, wherein in the converting of the decoded image data, converting the decoded image data and decoding the encoded image data are performed concurrently.

9. The method of claim 6, wherein the converting speed of the decoded image data is equal to or higher than the decoding speed of the encoded image.

10. The method of claim 6, further comprising:
rotating the location of the converted image data to be displayed on the screen.

11. A circuit for providing image data for display comprising:
a signal conversion unit configured to receive JPEG decompressed image data organized as horizontal block lines of an image directly from a JPEG compliant decoding unit.

12. A circuit according to claim 11 wherein the JPEG compliant decoding unit is configured to decode encoded image data to provide the JPEG decompressed image data under control of the signal conversion unit.

13. A circuit according to claim 12 wherein the signal conversion unit further comprises a data buffer having a capacity to store a single horizontal block line of JPEG decompressed image data.

14. A circuit according to claim 13 wherein the signal conversion unit provides a stop signal to the JPEG compliant decoding unit when the data buffer is full.

15. A circuit according to claim 14 wherein the signal conversion unit provides a start signal to the JPEG compliant decoding unit when the data buffer is empty.

16. A circuit according to claim 15 wherein the signal conversion unit is further configured to operate on the JPEG decompressed image data in the data buffer when the data buffer is not empty.

17. A circuit according to claim 15 wherein the signal conversion unit is further configured to stop a pixel clock signal to a camera interface circuit when the data buffer is empty.

18. A circuit according to claim 13 wherein the data buffer comprises a first data buffer, the signal conversion unit further comprising a second data buffer configured to store JPEG decompressed image data when the first data buffer is full.

19. A circuit according to claim 11 wherein the signal conversion unit is further configured to operate on the JPEG decompressed image data without reading the JPEG decompressed image data from an external memory outside the signal conversion unit and outside the JPEG compliant decoding unit.

20. A circuit according to claim 11 further comprising:
a camera interface unit configured to receive the camera image data from the signal conversion unit, wherein the camera interface unit provides prost processing of the camera image data including rotation of the camera image data and/or scaling of the camera image data.
